(19) United States
(12) Patent Application Publication
(10) Pub. No.: US 2021/0043153 A1
(43) Pub. Date: Feb. 11, 2021

(54) Gray level adjustment circuit and method

(71) Applicant: NOVATEK Microelectronics Corp., Hsin-Chu (TW)

(72) Inventors: Yun-Shu Yang, Changhua County (TW); Yen-Tao Liao, Hsinchu City (TW); Hongchun Cong, Xi'an City (CN)

(21) Appl. No.: 16/547,586

(22) Filed: Aug. 22, 2019

(30) Foreign Application Priority Data
Aug. 8, 2019 (CN) 201910731810.7

(51) Int. Cl. G09G 3/36

(52) U.S. Cl. CPC G09G 3/3607; G09G 2320/0242; G09G 2320/0285; G09G 2320/0673

(57) ABSTRACT

A method of gray level adjustment for an image data generator includes receiving a plurality of image frames including a first image frame and a second image frame next to the first image frame, wherein the first image frame includes a first input subpixel data corresponding to a first subpixel of a display panel and the second image frame includes a second input subpixel data corresponding to the first subpixel; with respect to the first input subpixel data, outputting a first gray level data of a first gamma lookup table as a first output subpixel data; and with respect to the second input subpixel data, outputting a second gray level data of a second gamma lookup table as a second output subpixel data. The first output subpixel data and the second output subpixel data are corresponding to the first subpixel of the display panel.

### BACKGROUND OF THE INVENTION

### 1. Field of the Invention

The present invention relates to a gray level adjustment circuit and method, and more particularly, to a gray level adjustment circuit and method for generating output subpixel data according to input subpixel data after the gray levels of the input subpixel data are adjusted based on gamma lookup tables.

### 2. Description of the Prior Art

A liquid crystal display (LCD) generally has an off-angle viewing problem where the image may possess color distortion or color washout at a side view angle, which means a user feels the display panel brighter when looking at the side view angle. In the prior art, two gamma lookup tables (LUTs) are applied to modify the pixel data or subpixel data (gray level data) to mitigate the off-angle viewing problem. In detail, the two gamma LUTs include a high gamma LUT that converts input data to output data of higher gray levels and a low gamma LUT that converts input data to output data of lower gray levels. Each subpixel data is converted by one of the gamma LUTs. For example, a subpixel may be divided into two parts, where one part displays subpixel data converted by the high gamma LUT and the other part displays subpixel data converted by the low gamma LUT. If these two subpixel data are identical before the conversions, the high gamma LUT may output subpixel data of higher gray level which presents higher brightness and the low gamma LUT may output subpixel data of lower gray level which presents lower brightness. In another example, one subpixel displays subpixel data converted by the high gamma LUT and a neighboring subpixel displays subpixel data converted by the low gamma LUT. In such a situation, the off-angle viewing problem in a panel may be mitigated, and the improvement is much evident in a vertical alignment (VA) panel.

However, the implementations of different gamma LUTs for neighboring subpixels result in a side effect where there may be grids appearing in the image. The grids, which may be generated due to the gray level difference between the high/low gamma LUTs, reduce visual experience. Thus, there is a need for improvement over the prior art.

### SUMMARY OF THE INVENTION

It is therefore an objective of the present invention to provide a gray level adjustment circuit and a related method, to solve the off-angle viewing problem and also prevent the grid image problem mentioned above.

An embodiment of the present invention discloses a method of gray level adjustment for an image data generator. The method comprises receiving a plurality of image frames comprising a first image frame and a second image frame next to the first image frame, wherein the first image frame comprises a first input subpixel data corresponding to a first subpixel of a display panel and the second image frame comprises a second input subpixel data corresponding to the first subpixel; with respect to the first input subpixel data, outputting a first gray level data of a first gamma lookup table as a first output subpixel data; and with respect to the second input subpixel data, outputting a second gray level data of a second gamma lookup table as a second output subpixel data. The first output subpixel data and the second output subpixel data are corresponding to the first subpixel of the display panel.

Another embodiment of the present invention discloses a gray level adjustment circuit, which comprises a memory controller and a data selector. The memory controller is configured for receiving a plurality of image frames comprising a first image frame and a second image frame next to the first image frame, wherein the first image frame comprises a first input subpixel data corresponding to a first subpixel of a display panel and the second image frame comprises a second input subpixel data corresponding to the first subpixel. The data selector is configured for outputting a first gray level data of a first gamma lookup table as a first output subpixel data with respect to the first input subpixel data, and outputting a second gray level data of a second gamma lookup table as a second output subpixel data with respect to the second input subpixel data. The first output subpixel data and the second output subpixel data are corresponding to the first subpixel of the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A and 1B are schematic diagrams of a gamma LUT assignment indicating which subpixel data to be selected from high and low gamma LUTs.

FIG. 2 is a schematic diagram of a gray level adjustment circuit according to an embodiment of the present invention.

FIG. 3 is a schematic diagram of the assignment of high/low gamma LUTs arranged in a table with respect to 4×4 pixels.

FIG. 4 is a schematic diagram of assignment values for subpixels in an image frame according to the assignment table shown in FIG. 3.

FIG. 5 illustrates an exemplary gamma LUT for converting gray levels from 8-bit input data into 12-bit output data.

FIG. 6 is a schematic diagram of a gray level adjustment process according to an embodiment of the present invention.

### DETAILED DESCRIPTION

In order to solve the off-angle viewing problem and also mitigate the grid effect, the present invention provides a gray level adjustment method which deals with the pixel data or subpixel data in time domain. According to embodiments of the present invention, each pixel or subpixel may display pixel data or subpixel data converted by the high gamma lookup table (LUT) in a specific image frame and display pixel data or subpixel data converted by the low gamma LUT in another image frame, so that the grid effect in the image may be mitigated or eliminated.

In order to control the selection between the high gamma LUT and the low gamma LUT for each input data, gamma LUT assignment may be realized and implemented differently from frame to frame. In an embodiment, with respect to a first input subpixel data corresponding to a specific subpixel in an image frame, the corresponding output subpixel data is the gray level data outputted from a first gamma LUT such as the high gamma LUT; with respect to a second input subpixel data corresponding to the same subpixel in another image frame, the corresponding output subpixel data is the gray level data outputted from a second gamma LUT such as the low gamma LUT.

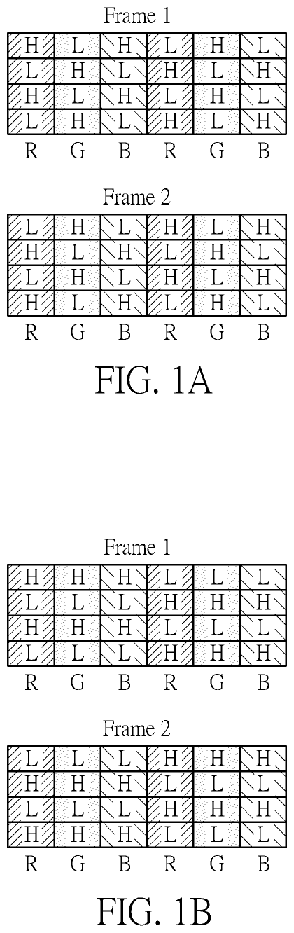

Please refer to FIGS. 1A and 1B, which are schematic diagrams of a gamma LUT assignment indicating which subpixel data to be selected from high and low gamma LUTs. In FIGS. 1A and 1B, the gamma LUT assignment is presented by a table (called an assignment table hereinafter) for 4×2 pixels, and the gamma LUT indications “H”, “L” in frame 1 and frame 2 show that each subpixel displays subpixel data converted based on the high and low gamma LUTs, respectively. In the example of FIG. 1A, for the red subpixel in the upper leftmost side, the red subpixel data is converted by the high gamma LUT in frame 1 and converted by the low gamma LUT in frame 2. In the example of FIG. 1B, for the first pixel (including R, G, B subpixels) in the upper leftmost side, the pixel data (including R subpixel data, B subpixel data and G subpixel data) is converted by the high gamma LUT in frame 1 and converted by the low gamma LUT in frame 2.

Since the subpixel data for each subpixel or pixel data for each pixel is converted by different gamma LUTs in different frames, the unwanted grid effect may be mitigated or eliminated. This is because fast transitions of high and low gamma LUTs in time domain may generate similar time-average brightness in neighboring subpixels or pixels.

Please note that the above implementation is one of various embodiments of the present invention. In another embodiment, for a specific subpixel or pixel, the subpixel data or pixel data in frames 1 and 2 may be converted by one gamma LUT and the subpixel data or pixel data in frames 3 and 4 may be converted by another gamma LUT. This gamma LUT alternation method may also mitigate or eliminate the unwanted grid effect. In a further embodiment, there may be more than two gamma LUTs for converting the subpixel data or pixel data. For example, there are a high gamma LUT, a medium gamma LUT and a low gamma LUT with different gray level conversions, and the subpixel data for each subpixel may be converted by one of the three gamma LUTs in every frame.

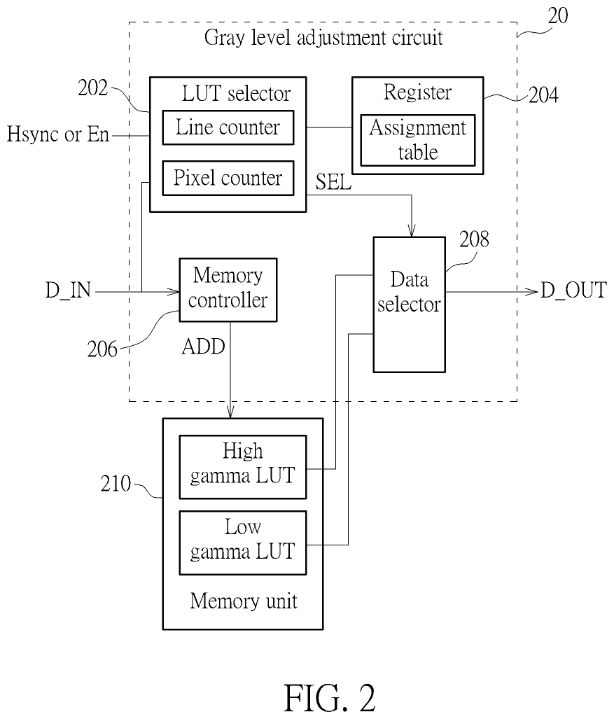

Please refer to FIG. 2, which is a schematic diagram of a gray level adjustment circuit 20 according to an embodiment of the present invention. The gray level adjustment circuit 20 is configured for performing a dual gamma function.

As shown in FIG. 2, the gray level adjustment circuit 20 includes a LUT selector 202, a register 204, a memory controller 206, and a data selector 208. The gray level adjustment circuit 20 is coupled to a memory unit 210 (e.g., SRAM) storing a plurality of gamma LUTs, which include but not limited to a high gamma LUT and a low gamma LUT. It is noted that R/G/B subpixels have respective high and low gamma LUTs so the actual gamma LUTs stored in the memory unit 210 may include at least six gamma LUTs. The register 204 is configured to store the assignment table having assignment values indicating the high/low gamma LUTs for input data (pixel data) of the gray level adjustment circuit 20, such as the assignment tables shown in FIG. 1A or 1B, where the assignment tables for different frames have different allocations of assignment values. If two gamma LUTs are used, 1-bit assignment value may be enough to present two different gamma LUTs, where the low gamma LUT (denoted as L in FIGS. 1A and 1B) may be indicated by an assignment value 0 and the high gamma LUT (denoted as H in FIGS. 1A and 1B) may be indicated by an assignment value 1, for example. In other words, the register 204 stores bits indicating the gamma LUTs with the assignment table, which is mapped to an array formed by a group of subpixels.

The memory controller 206 receives an input subpixel data D_IN of every subpixel and generates an address signal ADD corresponding to the input subpixel data D_IN of every subpixel in the image frames. The memory controller 206 outputs the address signal ADD to the memory unit 210 so that the data (gray level data) stored in the high gamma LUT and the low gamma LUT, indicated by the address signal ADD, can be read out. The LUT selector 202 receives the input subpixel data D_IN and selects an assignment value from the assignment table, and then generates a select signal SEL according to the selected assignment value to control the data selector 208 to selectively output a higher gray level from the high gamma LUT or a lower gray level value from the low gamma LUT. The data selector 208 receives a first output subpixel data (of a higher gray level) from the high gamma LUT and a second output subpixel data (of a lower gray level) from the low gamma LUT, respectively, and outputs one of the first output subpixel data and the second output subpixel data as an actual output subpixel data D_OUT according to the select signal SEL from the LUT selector 202. For example, the memory controller 206 may convert a 12-bit input subpixel data (i.e., subpixel data of an original gray level) into an 8-bit address signal, and a 12-bit output subpixel data (i.e., subpixel data of an adjusted gray level) can be obtained from the 8-bit address signal.

In an embodiment, the data selector 208 may be a multiplexer which is capable of selecting one of the received gray level data to output an output subpixel data based on the select signal. Those skilled in the art should recognize that the implementation of the data selector 208 is not a limitation of the present invention.

In an embodiment, the LUT selector 202 may include a line counter and a pixel counter. The LUT selector 202 selects the assignment value from the assignment table according to a line counting value of the line counter and a pixel counting value of the pixel counter, and thereby generates the select signal SEL. The line counting value and the pixel counting value may indicate a location where the assignment value is stored in the assignment table.

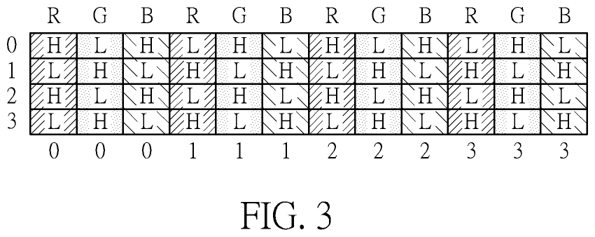

In detail, the line counter may count line data (which means pixel data of a display line, i.e., a pixel row) based on a horizontal synchronization signal (Hsync) or a data enable signal (En), which indicates that pixel data of a line are completely processed and pixel data of another line will be received subsequently. The pixel counter may count pixel data. The assignment of high/low gamma LUTs is arranged in a table with respect to m×n pixels, such as 4×4 pixels shown in FIG. 3. Based on the size of the assignment table in FIG. 3, the line counting value of the line counter and the pixel counting value of the pixel counter may be presented by 2-bit values 00, 01, 10, and 11, as 0 to 3 denoted in the left side (with respect to line) of the assignment table and the lower side (with respect to pixel data) of the assignment table. Each pixel includes three subpixels with RGB colors, respectively. Therefore, the assignment table stored in the register 204 includes 4×4×3=48 bits of assignment values for indicating the gamma LUT to be used to convert subpixel data. The RGB subpixel data in a pixel are received consecutively in a predetermined R-G-B order, and may not need additional bits to record their relative positions.

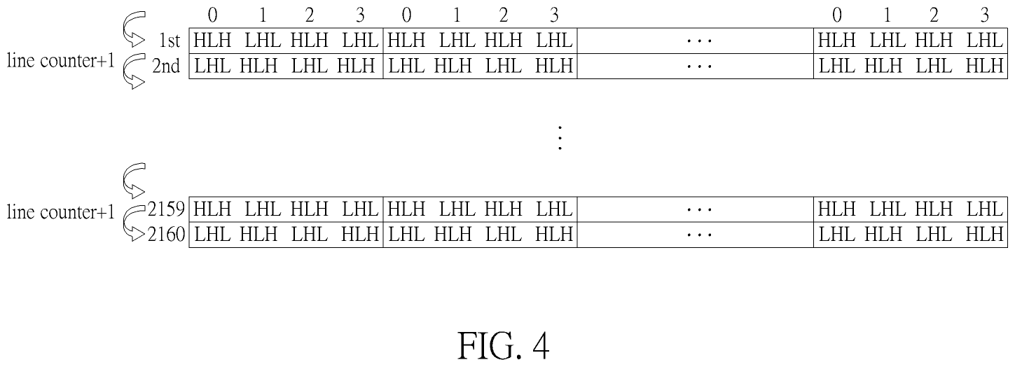

The pixel data or subpixel data may enter the gray level adjustment circuit 20 in sequence and line by line. For example, pixel data of the first line enters the gray level adjustment circuit 20 in sequence, and the pixel data of the second line enters the gray level adjustment circuit 20 in sequence, and so on. FIG. 4 is a schematic diagram of assignment values for subpixels in an image frame according to the assignment table shown in FIG. 3. FIG. 4 takes a 4k2k panel which has a resolution of 3840×2160 pixels as an example, and an image frame has 2160 line data and each line data includes pixel data of 3840 pixels (i.e., 3840×3 subpixels), as shown in FIG. 4.

When the memory controller 206 receives the first subpixel data (e.g. the leftmost subpixel data) of the first line data of a frame, the memory controller 206 converts the first subpixel data to an address signal, e.g., ADD_00R, for obtaining a corresponding output subpixel data stored in an address corresponding to the address signal ADD_00R. On the other side, when the LUT selector 202 receives the first subpixel data of the first line data, the counting result of the line counter (i.e., the line counting value) may be 2-bit value 00 and the counting result of the pixel counter (i.e., the pixel counting value) may be 00 (as ‘0’ denoted in FIG. 4), and the LUT selector 202 obtains an assignment value 1, which is to be used as the select signal SEL (or used for generating the select signal SEL) to control the data selector 208. Consequently, the gray level data stored in the high gamma LUT (as ‘H’ denoted in FIG. 4) indicated by the address signal ADD_00R can be read out and outputted by the data selector 208 as the output subpixel data D_OUT. In other words, the first subpixel (red subpixel) of the first (the leftmost) pixel of the first display line displays subpixel data converted by the high gamma LUT.

Subsequently, when the memory controller 206 receives the second subpixel data of the first line data of the frame, the memory controller 206 converts the second subpixel data to an address signal, e.g., ADD_00G. On the other side, when the LUT selector 202 receives the second subpixel data of the first line data, the counting result of the line counter may be still 2-bit value 00 and the counting result of the pixel counter may be still 00 (as ‘0’ denoted in FIG. 4). Although the counting results are identical to the case when the first subpixel data is received, the LUT selector 202 knows that the second subpixel data is the second data belonging to the same pixel and obtains an assignment value 0, which is to be used as the select signal SEL (or used for generating the select signal SEL) to control the data selector 208. Consequently, the gray level data stored in the low gamma LUT indicated by the address signal ADD_00G can be read out and outputted by the data selector 208 as the output subpixel data D_OUT. In other words, the second subpixel (green subpixel) of the first (the leftmost) pixel of the first display line displays subpixel data converted by the low gamma LUT.

In this manner, the memory controller 206 receives the third subpixel data of the first line data of the frame and converts this subpixel data to a corresponding address signal, e.g., ADD_00B. The LUT selector 202 receives the third subpixel data while the counting results of the line counter and the pixel counter are still the same (i.e., 00). The LUT selector 202 knows that the third subpixel data is the third data belonging to the same pixel and obtains an assignment value 1 to be used as the select signal SEL (or used for generating the select signal SEL) to control the data selector 208. Consequently, the gray level data stored in the high gamma LUT indicated by the address signal ADD_00B can be read out and outputted by the data selector 208 as the output subpixel data D_OUT.

Subsequently, when the memory controller 206 receives the fourth subpixel data of the first line data of the frame, the memory controller 206 converts the fourth subpixel data to a corresponding address signal, e.g., ADD_01R. On the other side, when the LUT selector 202 receives the fourth subpixel data of the first line data, the counting result of the line counter may still be 00 while the counting result of the pixel counter may become 01 (as ‘1’ denoted in FIG. 4). The LUT selector 202 knows that the fourth subpixel data is the first data belonging to the second pixel of the first line data and obtains an assignment value 0 to be used as the select signal SEL (or used for generating the select signal SEL) to control the data selector 208. Consequently, the gray level data stored in the low gamma LUT indicated by the address signal ADD_01R can be read out and outputted by the data selector 208 as the output subpixel data D_OUT. In this manner, the gray level adjustment circuit 20 deals with four consecutive pixel data (i.e., 12 consecutive subpixel data for 12 subpixels) according to the gamma LUT assignment determined by the LUT selector 202, with the counting results ‘0’ to ‘3’ of the pixel counter.

When the LUT selector 202 receives the 13^{th} subpixel data of the first line data, the counting result of the line counter may still be 00 while the counting result of the pixel counter changes from 11 (as ‘3’) to 00 (as ‘0’). Based on the counting results of the line counter and the pixel counter, the LUT selector 202 obtains an assignment value 1 to be used as the select signal SEL (or used for generating the select signal SEL) to control the data selector 208. Consequently, the gray level data stored in the high gamma LUT indicated by the address signal can be read out and outputted by the data selector 208 as the output subpixel data D_OUT. By the same token, output subpixel data D_OUT of the first line data may be completely generated according to the gamma LUT assignment (as “HLHLHLHLHLHL . . . ” denoted in FIG. 4) determined by the LUT selector 202.

After the first line data is completely processed, the gray level adjustment circuit 20 may process the second line data to find out the output subpixel data D_OUT with an adjusted gray level according to the assignment values indicating “LHL HLH LHL HLH” shown in FIG. 4. In this manner, the gray level adjustment circuit 20 may convert an entire frame of pixel data. Subsequently, the second frame of pixel data may enter the gray level adjustment circuit 20 after the first frame of pixel data is converted, and the gray level adjustment circuit 20 may repeat the above operations to convert the second frame of pixel data.

Please note that the abovementioned assignment table with respect to 4×4 pixels configured for selecting the gamma LUT is one of various embodiments of the present invention. In another embodiment, the 4×4 table may include another high/low gamma LUT arrangement, such as “HHHLLLHHHLLL” for 4 consecutive pixels in a line, which means the gamma LUT is changed by pixel, not by subpixel, in time domain. In a further embodiment, the assignment table size may be different, such as 2×2 pixels or 8×8 pixels, which should not be a limitation of the present invention.

The gray level adjustment circuit of the present invention receives input pixel data or input subpixel data and generates output pixel data or output subpixel data after conversion of a gamma LUT. In other words, the output results of the gray level adjustment circuit 20 are pixel data or subpixel data with the adjusted gray levels to be displayed. In an embodiment, the gray level adjustment circuit 20 may deal with 12-bit input subpixel data (i.e., 12-bit gray level). In order to save the memory size, the memory controller 206 may compress or convert the 12-bit input subpixel data to generate an 8-bit address signal for the gamma LUTs. When the 12-bit input subpixel data enters the gray level adjustment circuit 20, the memory controller 206 converts the 12-bit input subpixel data into the 8-bit address signal. The memory controller 206 forwards the 8-bit address signal to the memory unit 210. Subsequently, the memory unit 210 outputs a 12-bit output subpixel data with a higher gray level stored in the high gamma LUT and/or a 12-bit output subpixel data with a lower gray level stored in the low gamma LUT.

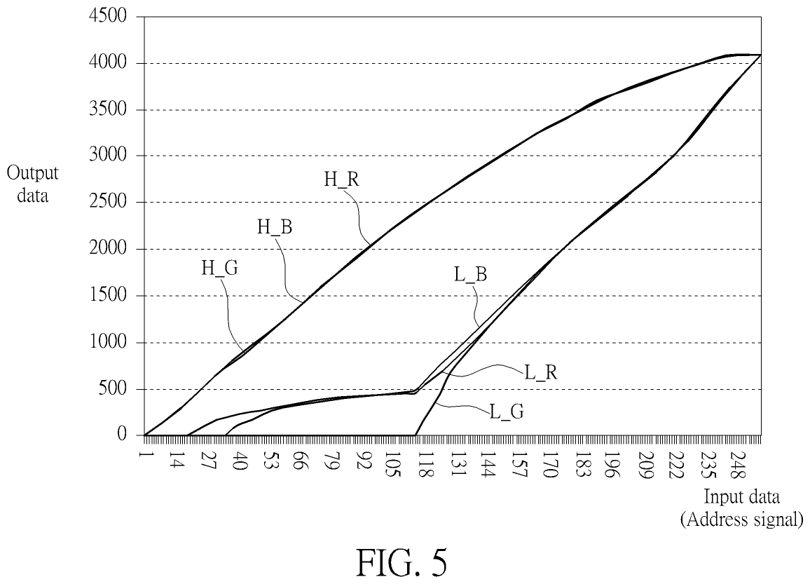

FIG. 5 illustrates an exemplary gamma LUT for converting gray levels, where the input data (x-axis) has 8-bit gray level (i.e., values 0-255) and the output data (y-axis) is represented by 12-bit gray level (i.e., values 0-4095). It is noted that data of the x-axis of FIG. 5 does not mean the input pixel data to the gray level adjustment circuit but means the input data (as address signal) of the gamma LUT. Note that the RGB subpixels have different high and low gamma LUTs due to their different panel characteristics. In an embodiment, the high gamma LUTs for the R, G, and B subpixels (H_R, H_G, and H_B) are similar, but their low gamma LUTs (L_R, L_G, and L_B) are somewhat different, especially for lower input data, as shown in FIG. 5. Further note that, the conversion of the gamma LUT shown in FIG. 5 is decided by the panel characteristics. Different panels may possess different panel characteristics, and thereby require different gamma LUTs. In an embodiment, the gray level values included in the gamma LUTs may be adjusted based on the panel characteristics.

Please note that the present invention aims at providing a gray level adjustment circuit and a related method where the gamma LUT assignment of the assignment table is implemented differently from frame to frame. Those skilled in the art may make modifications and alternations accordingly. For example, in the above embodiment, the memory controller 206 receives the input subpixel data D_IN, converts it into the address signal ADD, and transmits the address signal ADD to the memory unit 210. The LUT selector 202 receives the input subpixel data D_IN and selects an assignment value from the assignment table stored in the register 204 to generate the select signal SEL. The data selector 208 then receives the select signal SEL and receives the gray level data from the high gamma LUT and the low gamma LUT, to output one of the gray level data according to the select signal SEL. In another embodiment, the gray level adjustment circuit may be implemented in other manners. For example, the memory unit may receive the select signal SEL from the LUT selector so as to determine which gamma LUT is enabled to output gray level data. In this example, the data selector may be not necessary. In another embodiment, the data selector may be implemented in the memory unit. If the select signal received by the data selector carries an assignment value indicating the high gamma LUT, the data selector may enable the high gamma LUT to output the gray level data while disable the low gamma LUT.

It should also be noted that the gray level adjustment circuit and method of the present invention are applicable to an image data generator for a display panel. For example, the gray level adjustment circuit may be implemented in a timing controller, or any other type of image processing device or controller integrated circuit (IC). In an embodiment, the gray level adjustment circuit may be implemented between a digital gamma module and an overdrive module in the timing controller. The digital gamma module realizes gamma correction (e.g., Gamma 2.2). The pixel data or subpixel data may undergo gamma correction in the digital gamma module, then be processed by the gray level adjustment circuit for eliminating or mitigating the off-angle viewing problem and grid effect in the image, and then be processed by the overdrive module.

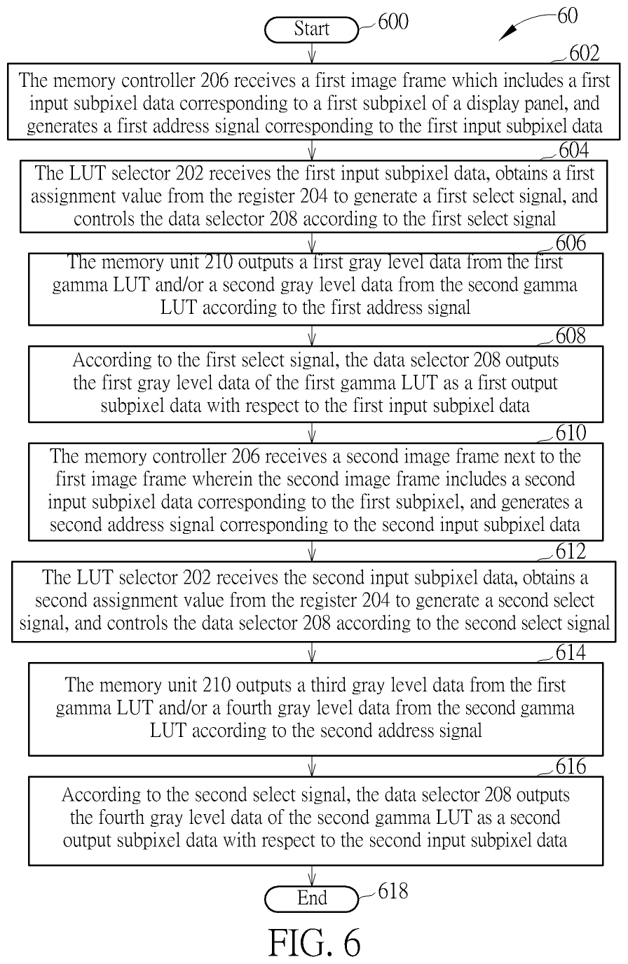

The abovementioned operations of the gray level adjustment circuit 20 may be summarized into a gray level adjustment process 60, as shown in FIG. 6. The gray level adjustment process 60 includes the following steps:

Step 600: Start.

Step 602: The memory controller 206 receives a first image frame which includes a first input subpixel data corresponding to a first subpixel of a display panel, and generates a first address signal corresponding to the first input subpixel data.

Step 604: The LUT selector 202 receives the first input subpixel data, obtains a first assignment value from the register 204 to generate a first select signal, and controls the data selector 208 according to the first select signal.

Step 606: The memory unit 210 outputs a first gray level data from the first gamma LUT and/or a second gray level data from the second gamma LUT according to the first address signal.

Step 608: According to the first select signal, the data selector 208 outputs the first gray level data of the first gamma LUT as a first output subpixel data with respect to the first input subpixel data.

Step 610: The memory controller 206 receives a second image frame next to the first image frame wherein the second image frame includes a second input subpixel data corresponding to the first subpixel, and generates a second address signal corresponding to the second input subpixel data.

Step 612: The LUT selector 202 receives the second input subpixel data, obtains a second assignment value from the register 204 to generate a second select signal, and controls the data selector 208 according to the second select signal.

Step 614: The memory unit 210 outputs a third gray level data from the first gamma LUT and/or a fourth gray level data from the second gamma LUT according to the second address signal.

Step 616: According to the second select signal, the data selector 208 outputs the fourth gray level data of the second gamma LUT as a second output subpixel data with respect to the second input subpixel data.

Step 618: End.

The gray level adjustment process 60 includes gray level adjustments performed on every input subpixel data by considering the same subpixel of different image frames. Further, it is not necessary that the operations of the gray level adjustment process 60 follow the order of the specified steps. For example, the LUT selector 202 may receive the input subpixel data before, after, or when this input subpixel data is received by the memory controller 206. Alternatively or additionally, when the data selector 208 obtains the gray level data from the memory unit 210, the memory controller 206 may have started to receive the next input subpixel data for generating the next address signal. Other detailed operations and alternations of the gray level adjustment process 60 are described in the above paragraphs, and will not be narrated herein.

To sum up, the present invention provides a gray level adjustment circuit and a related method where the gamma LUT assignment of the assignment table is implemented differently from frame to frame. Therefore, for a specific subpixel, the output subpixel data in a first frame may be obtained from the gray level data of a first gamma LUT (e.g., the high gamma LUT), and the output subpixel data in a second frame next to the first frame may be obtained from the gray level data of a second gamma LUT (e.g., the low gamma LUT). This prevents the off-angle viewing problem and also mitigates or eliminates the unwanted grid effect in the output image.

Those skilled in the art will readily observe that numerous modifications and alterations of the device and method may be made while retaining the teachings of the invention. Accordingly, the above disclosure should be construed as limited only by the metes and bounds of the appended claims.

1. A method of gray level adjustment for a timing controller, comprising:
receiving a plurality of image frames comprising a first image frame and a second image frame next to the first image frame, wherein the first image frame comprises a first input subpixel data corresponding to a first subpixel of a display panel and the second image frame comprises a second input subpixel data corresponding to the first subpixel;
with respect to the first input subpixel data, outputting, by the timing controller, a first gray level data of a first gamma lookup table as a first output subpixel data without using a second gamma lookup table for the first input subpixel data; and
with respect to the second input subpixel data, outputting, by the timing controller, a second gray level data of the second gamma lookup table as a second output subpixel data without using the first gamma lookup table for the second input subpixel data,
wherein the first output subpixel data and the second output subpixel data are corresponding to the first subpixel of the display panel.

2. The method of claim 1, further comprising:
generating an address signal corresponding to each input subpixel data of each of the plurality of image frames;
obtaining the first gray level data of the first gamma lookup table which is as the first output subpixel data according to the address signal corresponding to the first input subpixel data; and
obtaining the second gray level data of the second gamma lookup table which is as the second output subpixel data according to the address signal corresponding to the second input subpixel data.

3. The method of claim 1, wherein outputting the first gray level data of the first gamma lookup table as the first output subpixel data comprises outputting the first gray level data of the first gamma lookup table as the first output subpixel data according to a first assignment value indicating the first gamma lookup table, and outputting the second gray level data of the second gamma lookup table as the second output subpixel data comprises outputting the second gray level data of the second gamma lookup table as the second output subpixel data according to a second assignment value indicating the second gamma lookup table, and wherein the first assignment value or the second assignment value is comprised in an assignment table, which is mapped to an array formed by a group of subpixels of the display panel.

4. The method of claim 3, wherein the assignment table for the first image frame and the assignment table for the second image frame have different allocations of assignment values.

5. The method of claim 3, further comprising:
selecting the first assignment value or the second assignment value based on a line counting value and a pixel counting value of a line counter and a pixel counter, which indicate a location where the first assignment value or the second assignment value is stored in the assignment table.

6. A gray level adjustment circuit of a timing controller, comprising:
a memory controller, for receiving a plurality of image frames comprising a first image frame and a second image frame next to the first image frame, wherein the first image frame comprises a first input subpixel data corresponding to a first subpixel of a display panel and the second image frame comprises a second input subpixel data corresponding to the first subpixel; and
a data selector, for outputting a first gray level data of a first gamma lookup table as a first output subpixel data without using a second gamma lookup table for the first input subpixel data with respect to the first input subpixel data, and outputting a second gray level data of the second gamma lookup table as a second output subpixel data without using the first gamma lookup table for the second input subpixel data with respect to the second input subpixel data,
wherein the first output subpixel data and the second output subpixel data are corresponding to the first subpixel of the display panel.

7. The gray level adjustment circuit of claim 6, wherein the memory controller is configured for generating an address signal corresponding to each input subpixel data of each of the plurality of image frames, and the data selector is configured for obtaining the first gray level data of the first gamma lookup table which is as the first output subpixel data according to the address signal corresponding to the first input subpixel data and obtaining the second gray level data of the second gamma lookup table which is as the second output subpixel data according to the address signal corresponding to the second input subpixel data.

8. The gray level adjustment circuit of claim 6, wherein the data selector is configured for outputting the first gray level data according to a first assignment value indicating the first gamma lookup table and outputting the second gray level data according to a second assignment value indicating the second gamma lookup table.

9. The gray level adjustment circuit of claim 8, further comprising:
a register, for storing an assignment table comprising the first assignment value or the second assignment value, wherein the assignment table is mapped to an array formed by a group of subpixels of the display panel.

10. The gray level adjustment circuit of claim 9, wherein the assignment table for the first image frame and the assignment table for the second image frame have different allocations of assignment values.

11. The gray level adjustment circuit of claim 9, further comprising:
a lookup table selector, coupled to the data selector and the register, for controlling the data selector to select the first assignment value or the second assignment value based on a line counting value and a pixel counting value of a line counter and a pixel counter, which indicate a location where the first assignment value or the second assignment value is stored in the assignment table.
